(19) United States
(12) Patent Application Publication
(10) Pub. No.: US 2026/0214617 A1
(43) Pub. Date: Jul. 23, 2026

(54) METHOD AND APPARATUSES FOR POSITIONING IN NON-TERRESTRIAL NETWORK

(71) Applicant: LENOVO (BEIJING) LIMITED, Beijing (CN)

(72) Inventors: Min XU, Beijing (CN); Jing HAN, Beijing (CN); Lianhai WU, Beijing (CN); Jie HU, Beijing (CN); Ran YUE, Beijing (CN)

(21) Appl. No.: 19/134,469

(22) PCT Filed: Feb. 24, 2023
(86) PCT No.: PCT/CN2023/078183

§ 371 Date: May 30, 2025

(51) Int. Cl. H04W 64/00; H04W 24/10

(52) U.S. Cl. CPC H04W 64/00; H04W 24/10

(57) ABSTRACT

Embodiments of the present application are related to methods and apparatuses for positioning in non-terrestrial network (NTN). An embodiment of the present application provides a positioning server including: a transceiver and a processor coupled to the transceiver, wherein the processor is configured to: receive, with the transceiver and from at least one of a base station (BS) or a user equipment (UE), assistant measurement information associated with a round trip time (RTT) measurement between the UE and a transmission and reception point (TRP) of the BS; and determine a RTT and locate the UE during a multi-RTT positioning procedure based at least partly on the assistance measurement information and an RTT measurement result, wherein the assistant measurement information includes at least one of the following: supplementary information associated with the UE and the TRP; timing information associated with the RTT measurement result; a first offset time difference of the RTT measurement result for the TRP; or a second offset time difference of the RTT measurement result for the UE.

### TECHNICAL FIELD

The present disclosure generally relates to methods and apparatuses for positioning in non-terrestrial network (NTN).

### BACKGROUND OF THE INVENTION

NTN refers to a network, or segment of networks using radio frequency (RF) resources on board a satellite. The satellite in NTN can be a Geostationary Earth Orbiting (GEO) satellite with fixed location to the Earth, or a Low Earth Orbiting (LEO) satellite orbiting around the Earth. 3rd Generation Partnership Project (3GPP) Rel-17 specifications have provided basic support of NTN features and in Rel-18 further enhancements including mobility are to be studied.

In some cases with NTN access, mobile network services can be offered through radio access technologies whose coverage could extend well beyond the political borders of countries wherein regulations of communication services could be different. Therefore, the network operator is mandated to cross check a user equipment (UE) location in order to fulfil the regulatory requirements regarding UE location. The verification of UE location could be necessary at least during initial access procedures e.g., to deny service if the UE operates in an exclusion area. Verification during UE service duration could also be needed to fulfill requirements of public warning system (PWS) or lawful interception. As a result, UE location verification by network is considered as one of the major objectives for Rel-18 NTN enhancements.

The UE positioning in NTN may be determined by a multiple round trip times (RTTs) positioning method. The UE position is estimated based on RTT measurement results acquired from the UE and at least one transmission and reception point (TRP), wherein each RTT measurement result is associated with the UE and a TRP and includes UE/BS reception-transmission (RX-TX) time difference measurements of downlink (DL) positioning reference signal (PRS) and uplink (UL) sounding reference signal (SRS). A location management function (LMF) entity calculates or derives the RTTs based on the RTT measurement results and determines the UE location in NTN.

### SUMMARY

Considering specific characteristics of the NTN (e.g., UE or TRP movement in NTN during a RTT measurement, or a TRP(s) move along the same orbit or in the same direction), it is proposed to take some measures to improve positioning accuracy for multi-RTT positioning in NTN.

Some embodiments of the present disclosure provide a positioning server including: a transceiver and a processor coupled to the transceiver, wherein the processor is configured to: receive, with the transceiver and from at least one of a base station (BS) or a UE, assistant measurement information associated with an RTT measurement between the UE and a TRP of the BS; and determine a RTT and locate the UE during a multi-RTT positioning procedure based at least partly on the assistance measurement information and an RTT measurement result, wherein the assistant measurement information includes at least one of the following: supplementary information associated with the UE and the TRP; timing information associated with the RTT measurement result; a first offset time difference of the RTT measurement result for the TRP; or a second offset time difference of the RTT measurement result for the UE.

In some embodiments, the supplementary information including at least one of the following: a horizontal angle between the UE and the TRP; at least one tracking area or radio access network (RAN) notification area (RNA) identity of the UE and mapping relationship between the at least one tracking area or RNA identity and a geographical location of the UE; a first reference location of the UE derived by the BS based on the at least one tracking area or RNA identity of the UE and the mapping relationship between the at least one tracking area or RNA identity of the UE and the geographical location of the UE; at least one neighbor cell of the UE and mapping relationship between the at least one neighbor cell of the UE and the geographical location of the UE; a second reference location of the UE derived by the BS based on the at least one neighbor cell of the UE and the mapping relationship between the at least one neighbor cell of the UE and the geographical location of the UE; at least one beam of the UE and mapping relationship between the at least one beam of the UE and the geographical location of the UE; a third reference location of the UE derived by the BS based on the at least one beam of the UE and the mapping relationship between the at least one beam of the UE and the geographical location of the UE.

In some embodiments, the RTT measurement result associated with the TRP and the UE includes at least one of: a first Rx-Tx time difference between a first time point when the TRP transmits a DL signal to the UE and a second time point when the TRP receives a UL signal from the UE; and a second Rx-Tx time difference between a third time point when the UE receives the DL signal and a fourth time point when the UE transmits the UL signal.

In some embodiments, the UL signal is UL SRS, and the DL signal is DL PRS.

In some embodiments, the timing information associated with the RTT measurement result includes the first time point and the second time point.

In some embodiments, the timing information associated with the RTT measurement result further includes the third time point and the fourth time point.

In some embodiments, the third time point and the fourth time point are derived by the BS based at least on an RX-TX time difference measurement configuration.

In some embodiments, the RX-TX time difference measurement configuration is associated with a DL PRS transmission window and a UL SRS reception window.

In some embodiments, the timing information associated with the RTT measurement result includes: a UE-specific timing advance between the UE and the TRP at the second time point.

In some embodiments, the first offset time difference is provided by the BS and equals to double of a time difference between the second time point and the fourth time point.

In some embodiments, the first offset time difference is provided by the BS and equals to a UE-specific timing advance between the UE and the TRP at the second time point.

In some embodiments, the UE-specific timing advance between the UE and the TRP at the second time point is reported from the UE in response to a request from the BS.

In some embodiments, the UE-specific timing advance between the UE and the TRP at the second time point is derived by the BS based on at least one of a previous UE-specific timing advance, a total adjusted timing advance before the second time point, and a common timing advance applied in a serving cell.

In some embodiments, timing information associated with the RTT measurement result includes one of the following: a UE-specific timing advance between the UE and the TRP at the second time point, or a UE-specific timing advance variation between the fourth time point and the second time point.

In some embodiments, timing information associated with the RTT measurement result includes a UE-specific timing advance variation rate at the fourth time point.

In some embodiments, the second offset time difference is provided by the UE and equals to a UE-specific timing advance variation between the fourth time point and the second time point plus the second Rx-Tx time difference.

In some embodiments, the positioning server transmits a request to at least one of the UE and the BS to receive the assistant measurement information.

In some embodiments, the positioning server configures at least one of the UE and the BS to transmit the assistant measurement information during or after the multi-RTT positioning procedure.

Some embodiments of the present disclosure provide a UE including: a transceiver and a processor coupled to the transceiver, wherein the processor is configured to: perform an RTT measurement between the UE and a TRP of a BS; and transmit assistant measurement information associated with the RTT measurement and an RTT measurement result to at least one of the BS or a positioning server, wherein the assistant measurement information includes at least one of the following: supplementary information for locating the UE; timing information associated with the RTT measurement; or a second offset time difference associated with the RTT measurement.

In some embodiments, the supplementary information includes at least one of the following: a horizontal angle between the UE and the TRP; at least one tracking area or RNA identity of the UE; at least one neighbor cell of the UE; or at least one beam of the UE.

In some embodiments, to perform the RTT measurement, the processor is configured to: receive, with the transceiver and from the TRP, a downlink (DL) signal at a first time point; and transmit, with the transceiver and to the TRP, an uplink (UL) signal at a second time point in response to the DL signal.

In some embodiments, the UL signal is UL SRS, and the DL signal is DL PRS.

In some embodiments, the timing information associated with the RTT measurement includes the first time point and the second time point.

In some embodiments, the timing information associated with the RTT measurement includes a UE-specific timing advance between the UE and the TRP at a third time point when the TRP receives the UL signal from the UE.

In some embodiments, the UE-specific timing advance between the UE and the TRP at the third time point is provided by the UE in response of receiving a request from the BS.

In some embodiments, the timing information associated with the RTT measurement includes one of the following: a UE-specific timing advance between the UE and the TRP at a third time point when the TRP receives the UL signal from the UE, or a UE-specific timing advance variation between the second time point and the third time point.

In some embodiments, the timing information associated with the RTT measurement includes a UE-specific timing advance variation rate at the second time point.

In some embodiments, the second offset time difference is determined based on: a UE-specific timing advance variation between the second time point and a third time point when the TRP receives the UL signal and a time difference between the first time point and the second time point.

In some embodiments, the third time point is provided by the BS; or the third time point is derived by the UE based on a UE-specific timing advance at the second time point.

Some embodiments of the present disclosure provide a BS including: a transceiver and a processor coupled to the transceiver, wherein the processor is configured to: perform an RTT measurement between a UE and a TRP of the BS; and transmit assistant measurement information and an RTT measurement result associated with the RTT measurement to a positioning server, wherein the assistant measurement information includes at least one of the following: supplementary information for locating the UE; timing information associated with the RTT measurement result; or a first offset time difference.

In some embodiments, the supplementary information includes at least one of: a horizontal angle between the UE and the TRP; at least one tracking area or RNA identity of the UE; mapping relationship between the at least one tracking area or RNA identity and a geographical location of the UE; a first reference location of the UE derived by the BS based on the at least one tracking area or RNA identity and the mapping relationship between the at least one tracking area or RNA identity and the geographical location of the UE; at least one neighbor cell of the UE; mapping relationship between the at least one neighbor cell and the geographical location of the UE; a second reference location of the UE derived by the BS based on the at least one neighbor cell of the UE and the mapping relationship between the at least one neighbor cell of the UE and the geographical location of the UE; at least one beam of the UE; mapping relationship between the at least one beam and the geographical location of the UE; a third reference location of the UE derived by the BS based on the at least one beam and the mapping relationship between the at least one beam and the geographical location of the UE.

In some embodiments, to perform the RTT measurement, the processor is configured to: transmit, with the transceiver and to a user equipment (UE), a downlink (DL) signal at a first time point; and receive, with the transceiver and from the UE, a UL signal at a second time point in response to the DL signal.

In some embodiments, the UL signal is UL SRS, and the DL signal is DL PRS.

In some embodiments, the RTT measurement result includes at least one of: a first Rx-Tx time difference between the first time point and the second time point when the TRP receives a UL signal from the UE; or a second Rx-Tx time difference between a third time point when the UE receives the DL signal and a fourth time point when the UE transmits the UL signal in response to the DL signal.

In some embodiments, the timing information associated with the RTT measurement result includes the first time point and the second time point.

In some embodiments, the timing information associated with the RTT measurement result further includes the third time point and the fourth time point.

In some embodiments, the timing information associated with the RTT measurement result includes a UE-specific timing advance between the UE and the TRP at the second time point.

In some embodiments, the UE-specific timing advance between the UE and the TRP at the second time point is received from the UE in response to a request transmitted from the BS to the UE.

In some embodiments, the UE-specific timing advance between the UE and the TRP at the second time point is derived by the BS based on at least one of a previous UE-specific timing advance, a total adjusted timing advance before the second time point, and a common timing advance applied in a serving cell.

In some embodiments, the offset time difference equals to double of a time difference between the fourth time point and the second time point.

In some embodiments, the third time point and the fourth time point are derived based at least on an RX-TX time difference measurement configuration; or the third time point and the fourth time point are received from the UE.

In some embodiments, the RX-TX time difference measurement configuration is associated with a DL PRS transmission window and a UL SRS reception window.

In some embodiments, the offset time difference equals to a UE-specific timing advance between the UE and the TRP at the second time point.

Some embodiments of the present disclosure provide a method performed by a positioning server. The method includes: receiving from at least one of a BS or a UE, assistant measurement information associated with an RTT measurement between the UE and a TRP of the BS; and determining a RTT and locate the UE during a multi-RTT positioning procedure based at least partly on the assistance measurement information and an RTT measurement result, wherein the assistant measurement information includes at least one of the following: supplementary information associated with the UE and the TRP; timing information associated with the RTT measurement result; a first offset time difference of the RTT measurement result for the TRP; or a second offset time difference of the RTT measurement result for the UE.

Some embodiments of the present disclosure provide a method performed by a UE. The method includes: performing an RTT measurement between the UE and a TRP of a BS; and transmitting assistant measurement information associated with the RTT measurement and an RTT measurement result to at least one of the BS or a positioning server, wherein the assistant measurement information includes at least one of the following: supplementary information for locating the UE; timing information associated with the RTT measurement; or a second offset time difference associated with the RTT measurement.

Some embodiments of the present disclosure provide a method performed by a BS. The method includes: performing an RTT measurement between a UE and a TRP of the BS; and transmitting assistant measurement information and an RTT measurement result associated with the RTT measurement to a positioning server, wherein the assistant measurement information includes at least one of the following: supplementary information for locating the UE; timing information associated with the RTT measurement result; an offset time difference.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates an exemplary multi-RTT positioning method in prior art.

FIG. 3 illustrates a “mirror issue” caused by the legacy multi-RTT positioning method.

FIG. 4 illustrates the effect of movements of the TRP or UE on an RTT measurement.

FIG. 5 illustrates a flowchart of an exemplary method 500 for identifying an actual location or discarding a mirror location of an UE according to some embodiments of the present disclosure.

FIG. 6 illustrates a flowchart of an exemplary method 600 for calculating an RTT with compensation for the negative effect of the movement of at least one of the TRP and the UE during an RTT measurement according to some embodiments of the present disclosure.

FIG. 7 illustrates a flowchart of an exemplary method 700 for calculating an RTT with compensation for the negative effect of the movement of at least one of the TRP and the UE during an RTT measurement according to some embodiments of the present disclosure.

FIG. 8 illustrates a simplified block diagram of an exemplary apparatus 800 according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 is a schematic diagram illustrating an exemplary NTN system 100 in NTN according to some embodiments of the present disclosure.

As shown in FIG. 1, the NTN system 100 in NTN includes: at least one TRP 102 of at least one node (e.g., a BS, not shown in FIG. 1) and at least one UE 101. Although one TRP and one UE are depicted in FIG. 1 for illustrative purpose, it is contemplated that any number of TRPs (of any number of nodes) and UEs may be included in the NTN system 100 according to various embodiments of the present disclosure.

The NTN system 100 is compatible with any type of network that is capable of sending and receiving wireless communication signals. For example, the NTN system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

According to some embodiments of the present application, the at least one UE 102 may be a vehicle UE (VUE) and/or power-saving UE (also referred to as power sensitive UE). The power-saving UE may be a vulnerable road users (VRU), public safety UE (PS-UE), and/or commercial sidelink UE (CS-UE) that is sensitive to power consumption. In an embodiment of the present application, a VRU may be a pedestrian UE (P-UE), cyclist UE, wheelchair UE or another UE which requires power saving compared with a VUE. In an embodiment of the present application, the UE 102 may be an LPHAP UE.

According to some other embodiments of the present application, the at least one UE 102 may be a computing device, such as a desktop computer, laptop computer, personal digital assistant (PDA), tablet computer, smart television (e.g., a television connected to the Internet), set-top boxes, game console, security system (including a security camera), vehicle on-board computer, network device (e.g., a router, a switch, or a modem), or the like.

According to some other embodiments of the present application, the at least one UE 102 may be a portable wireless communication device, smart phone, cellular telephone, flip phone, device having a subscriber identity module, personal computer, selective call receiver, or another device that is capable of sending and receiving communication signals on a wireless network.

According to some other embodiments of the present application, the at least one UE 102 may be a wearable device, such as a smart watch, fitness band, optical head-mounted display, or the like.

Moreover, the at least one UE 102 may be referred to as a subscriber unit, mobile, mobile station, user, terminal, mobile terminal, wireless terminal, fixed terminal, subscriber station, user terminal, or device, or described using other terminology used in the art.

According to some embodiments of the present disclosure, a node may be a satellite, an unmanned aerial vehicle, a device on a balloon, a high altitude platform (HAP), etc.; it may be configured with antenna unit(s) of a BS or may be an entire BS.

According to some embodiments of the present disclosure, a BS (not shown in FIG. 1) in the present disclosure may be referred to as an access point, an access terminal, a base, a macro cell, an RAN node, a next generation (NG) RAN node, a node-B, an enhanced or evolved node B (eNB), a generalized node B (gNB), a home node-B, a relay node, or a device, or described using other terminology used in the art.

According to some embodiments of the present disclosure, the at least one TRP 102 may be configured with antenna unit(s) of a node (e.g., BS) or may be an entire node.

According to some embodiments of the present disclosure, a positioning server (not shown in FIG. 1) may refer to a network element (e.g., an LMF entity) or network entity for supporting location services, which may be deployed for example, in a core network (CN) or in an RAN of the wireless communication system 100.

In some embodiments, when a UE (e.g., UE 102) is in a coverage area of a BS (or a node having the same or similar function), the UE may communicate with the BS for example via air interface (e.g., LTE or NR Uu interface).

In some embodiments, a positioning server may communicate with a BS (or a node having the same or similar function) via interface protocol (e.g., NR positioning protocol A (NRPPa) signaling), and may communicate with a UE (e.g., the UE 102) via LTE positioning protocol (LPP) signaling.

By using a multi-RTT positioning method for UE positioning in NTN, a location of a UE may be determined based on multiple RTTs between a UE and multiple TRPs at the same time or between a UE and a single TRP at multiple different times.

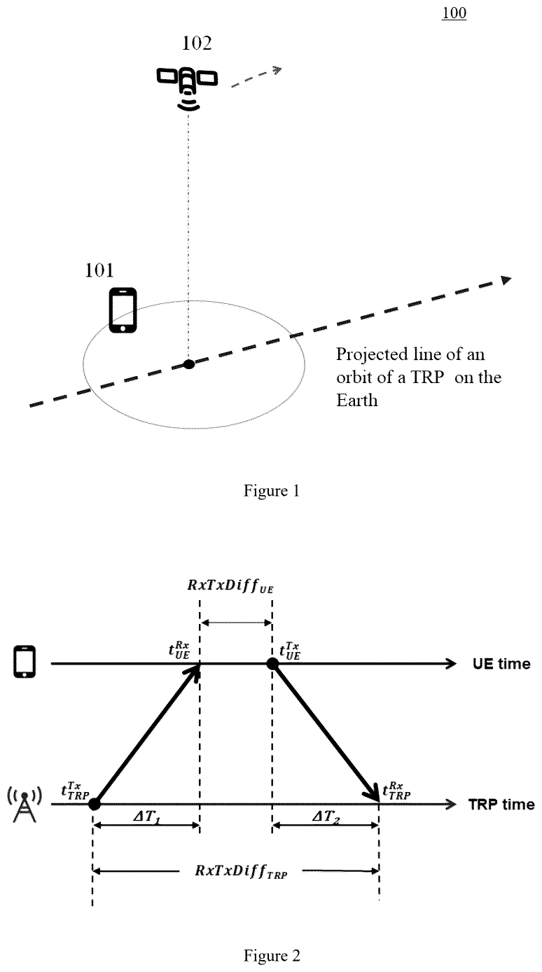

FIG. 2 illustrate a legacy method for measuring and calculating an RTT associated with a UE and a TRP during a multi-RTT positioning procedure inn prior art. To measure an RTT between the UE and the TRP, the TRP transmits a DL-PRS to the UE at a first time point

$$( i . e . , {t}_{TRP}^{Tx} ) ,$$

the UE receives the DL-PRS at a third time point

$$( i . e . , {t}_{UE}^{Rx} )$$

and processes the DL-PRS, and then transmit a UL-SRS to the TRP at a fourth time point

$$( i . e . , {t}_{UE}^{Tx} ) ;$$

the TRP receives me UL-SRS at a second time point

$$( i . e . , {t}_{TRP}^{Rx} ) .$$

The BS transmits a first Rx-Tx time difference (i.e., RxTxDiff_{TRP}) between

$${t}_{TRP}^{Tx} and {t}_{TRP}^{Rx}$$

to the LMF, and the UE transmits a second Rx-Tx time difference (i.e., RxTxDiff_{UE}) between

$${t}_{UE}^{Rx} and {t}_{UE}^{Tx}$$

to the LMF. The LMF may determine the RTT based on the RTT measurement result (including the first Rx-Tx time difference and the second Rx-Tx time difference) associated to the EU and the TRP to be:

$$\begin{matrix}RTT = ( {t}_{T R P}^{R x} - {t}_{T R P}^{T x} ) - ( {t}_{U E}^{T x} - {t}_{U E}^{R x} ) \\ = {RxTxDiff}_{TRP} - R x {TxDiff}_{UE} \\ = Δ T 1 + Δ T 2\end{matrix} \qquad ( Equation 1 )$$

Wherein ΔT1 is the time difference between

$${t}_{TRP}^{Tx} and {t}_{UE}^{Rx} ,$$

and ΔT2 is the time difference between

$${t}_{UE}^{Tx} and {t}_{TRP}^{Rx} .$$

However, this legacy RTT measurement and calculation method may cause some issues, which may decrease the accuracy of the UE positioning with multi-RTT positioning method.

For example, the legacy RTT measurement and calculation method does not consider that, when the multi-RTT positioning procedure is performed between a UE and a single TRP at different times or is performed between a UE and a multiple TRPs and the TRPs moves along the same orbit or in the same direction, the positioning server will derive two locations of the UE, one is the actual location of the UE, another is a mirror location of the UE, while the positioning server cannot identify or discard the mirror location of the UE. This is called as a “mirror issue”.

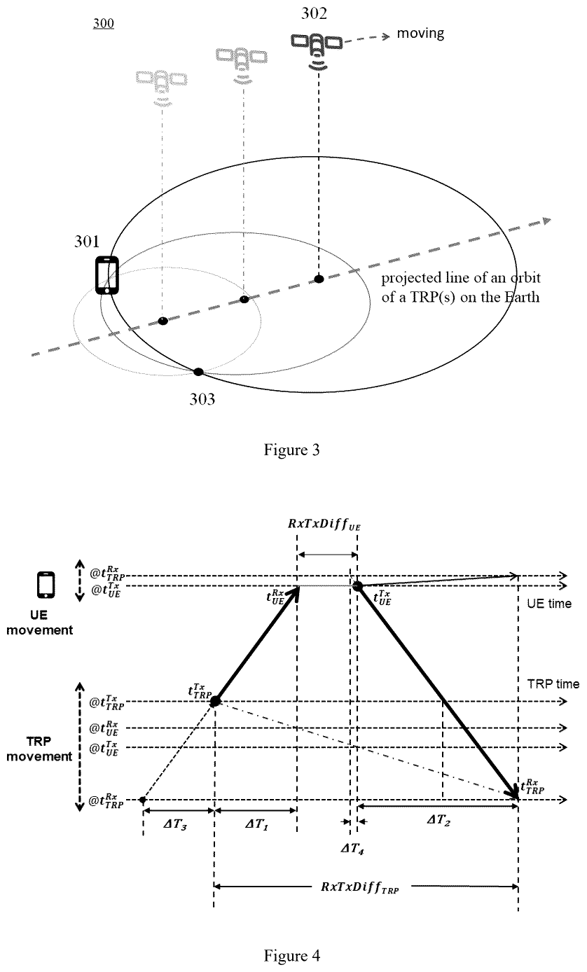

FIG. 3 illustrates such an exemplary “mirror issue.” In an exemplary NTN system 300, the multi-RTT positioning measurement is performed by measuring RTTs between UE 301 and a single TRP 302 at different times. As the TRP 302 moves along its orbit in one direction, the LMF may derive two possible locations for the UE 301, wherein one location is an actual location of the UE 301 and another location 303 is a mirrored location of the UE 301. Similar issue may occur when the multi-RTT positioning measurement is performed by measuring RTTs between a UE (e.g., UE 101) and multiple TRPs at the same time if the multiple TRPs move along the same orbit or in the same direction. In such cases, the LMF cannot identify the actual UE location based on the multiple RTT measurement results (each including a first Rx-Tx time difference RxTxDiff_{TRP} and a second Rx-Tx time difference RxTxDiff_{UE} associated with the UE and a TRP) only. This “mirror issue” occurs frequently unless the UE moves on the projected line of the orbit on the Earth or the TRPs moves in different directions.

Another issue caused by the legacy RTT measurement method is due to the TRP movement in NTN during the multi-RTT positioning procedure. Referring back to FIG. 2 as an example, the legacy RTT measurement between a UE and a TRP does not consider the movement of the TRP or the UE. However, in NTN, the TRP may keep moving during the multi-RTT positioning procedure; furthermore, the UE may also move time to time during the multi-RTT positioning procedure, although the movement of the UE may be much less than that of the TRP.

FIG. 4 illustrates the effect of the movement of the TRP and/or UE on the RTT measurement between a UE and a TRP.

As shown in FIG. 4, considering the TRP movement or the UE movement, the RTT may be:

$$\begin{matrix}RTT = RxTxDiffTRP - RxTxDiffUE + Δ T 3 + Δ T 4 \\ = Δ T 1 + Δ T 2 + Δ T 3 + Δ T 4\end{matrix} \qquad ( Equation 2 )$$

Wherein ΔT3 is caused due to the TRP movement during the entire RxTxDiff_{TRP}, and ΔT4 is caused due to the UE movement between

$${t}_{UE}^{Tx}$$

### (i.e, the end of RxTxDiff_{UE}) and

$${t}_{TRP}^{Rx}$$

### (i.e., the end of RxTxDiff_{TRP}).

Considering that the RTT measurement need to be performed multiple times in NTN during a multi-RTT positioning procedure and the moving speed of the TRP, such negligence of ΔT3 may lead to an error of kilometers in positioning result. In such a case the LMF cannot derive an accurate UE location in NTN. Moreover, although ΔT4 may be less than ΔT3 or even much less than ΔT3, it is still helpful to improve the UE positioning accuracy in NTN when considering ΔT4 during the multi-RTT positioning procedure.

The present disclosure provides various solutions to solve the aforementioned two issues.

According to some embodiments of the present disclosure, at least one of the UE or a BS (or a node having the similar function) provides assistant measurement information associated with an RTT measurement between the UE and the TRP to a positioning server (e.g., an LMF entity), the positioning server may determine an RTT during a multi-RTT positioning procedure based at least partly on the assistance measurement information and an RTT measurement result(s), wherein the assistant measurement information includes at least one of:
supplementary information associated with the UE and the TRP;
timing information associated with the RTT measurement result;
a first offset time difference of the RTT measurement result for the TRP; or
a second offset time difference of the RTT measurement result for the UE.

According to some embodiments, the positioning server may use the supplementary information associated with the TRP and the UE to identify an actual location of the UE and discard a mirror location of the UE.

In some embodiments, the UE or the BS provides the supplementary information directly to the positioning server. In some embodiments, the UE provides the supplementary information to the BS, and the BS forwards the supplementary information to the positioning server.

In some embodiments, the UE provides part of the supplementary information to the positioning server directly, and the BS provides the rest of the supplementary information to the positioning server directly.

In some embodiments, the UE provides part of the supplementary information to the BS, and the BS forwards the part of the supplementary information and transmits the rest of the supplementary information to the positioning server.

In some embodiments, the supplementary information including at least one of the following:
a horizontal angle between the UE and the TRP,
   the UE or the BS may provide this information to the positioning server;
at least one tracking area or RNA identity of the UE and mapping relationship between the at least one tracking area or RNA identity and a geographical location of the UE,
   the positioning server may derive a first reference location based on the at least one tracking area or RNA identity of the UE and the mapping relationship between the at least one tracking area or RNA identity of the UE and the geographical location of the UE,
   in some embodiments, the UE provides the at least one tracking area or RAN identity of the UE to the positioning server, and the BS provides the mapping relationship between the at least one tracking area or RNA identity and a geographical location of the UE to the positioning server,
   in some embodiments, the BS provides both the at least one tracking area or RAN identity of the UE and the mapping relationship between the at least one tracking area or RNA identity and a geographical location of the UE to the positioning server;
a first reference location of the UE,
   the BS derives the first reference location of the UE based on the at least one tracking area or RNA identity of the UE and the mapping relationship between the at least one tracking area or RNA identity of the UE and the geographical location of the UE;
at least one neighbor cell of the UE and mapping relationship between the at least one neighbor cell of the UE and the geographical location of the UE,
   the positioning server may derive a second reference location of the UE based on the at least one neighbor cell of the UE and the mapping relationship between the at least one neighbor cell of the UE and the geographical location of the UE,
   in some embodiments, the UE provides the at least one neighbor cell of the UE to the positioning server, and the BS provides the mapping relationship between the at least one neighbor cell of the UE and a geographical location of the UE to the positioning server,
   in some embodiments, the BS provides both the at least one neighbor cell of the UE and the mapping relationship between the at least one neighbor cell of the UE and a geographical location of the UE to the positioning server;
a second reference location of the UE provided by the BS,
   the BS derives the second reference location of the UE based on the at least one neighbor cell of the UE and the mapping relationship between the at least one neighbor cell of the UE and the geographical location of the UE;
at least one beam of the UE and mapping relationship between the at least one beam and the geographical location of the UE,
   the positioning server may derive a third reference location of the UE based on the at least one beam of the UE and the mapping relationship between the at least one beam of the UE and the geographical location of the UE,
   in some embodiments, the UE provides the at least one beam of the UE to the positioning server, and the BS provides the mapping relationship between the at least one beam of the UE and a geographical location of the UE to the positioning server,
   in some embodiments, the BS provides both the at least one beam of the UE and the mapping relationship between the at least one beam of the UE and a geographical location of the UE to the positioning server; or
a third reference location of the UE provided by the BS,
   the BS derives the third reference location based on the at least one beam of the UE and the mapping relationship between the at least one beam of the UE and the geographical location of the UE.

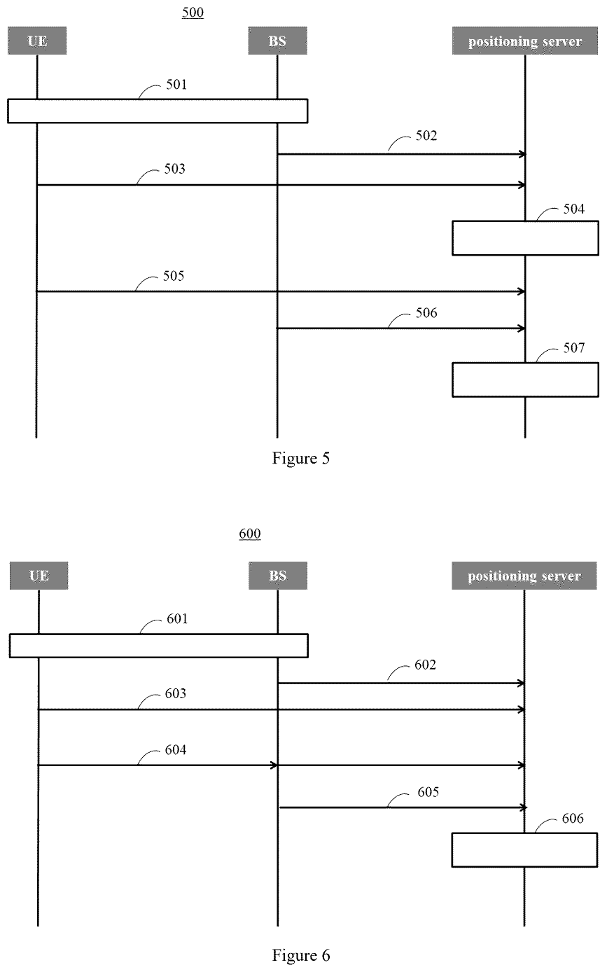

FIG. 5 illustrates a flowchart of an exemplary method 500 for identifying an actual location of a UE and discarding a mirror location of the UE by using the supplementary information according to some embodiments of the present disclosure. The method 500 illustrated in FIG. 5 may be performed by at least three entities, e.g., a UE (e.g., UE 101), a BS (not explicitly shown in FIG. 1), and a positioning server (e.g., an LMF entity). Although the method 500 is illustrated in a system level, persons skilled in the art can understand that the method implemented in the three entities can be separately implemented and incorporated in other apparatus with the like functions. It is also contemplated that the method 500 may include additional steps not shown.

In step 501, the BS and the UE perform an RTT measurement between the UE and a TRP of the BS. The TRP transmits a DL signal to the UE, the UE receives and processes the DL signal, and then transmit a UL signal to the TRP, the TRP receives the UL signal. In some embodiments, the UL signal is UL SRS, and the DL signal is DL PRS.

In step 502, the BS transmits a first Rx-Tx time difference (i.e., RxTxDiff_{TRP}) between

$${t}_{TRP}^{Tx} and {t}_{TRP}^{Rx}$$

### to the LMF.

In step 503, the UE transmits a second Rx-Tx time difference (i.e., RxTxDiff_{UE}) between

$${t}_{UE}^{Rx} and {t}_{UE}^{Tx}$$

to the LMF. It is contemplated that in some embodiments, there is no strict limit to the order of the step 502 and the step 503. In some embodiments, the UE may transmit the second Rx-Tx time difference to the BS, and the BS may forwards the second Rx-Tx time difference to the UE.

In step 504, the positioning server receives the first Rx-Tx time difference and the second Rx-Tx time difference, and calculates an RTT between the UE and the TRP of the BS based on the first Rx-Tx time difference and the second Rx-Tx time difference.

In some embodiments, at least one of step 505 or step 506 is executed; whether step 505 or step 506 is executed, or both step 505 and step 506 are executed, it depends at least partly upon the content of the supplementary information.

In step 505, the UE provides the supplementary information associated with the UE and the TRP or part of the supplementary information to the positioning server.

In step 506, the BS provides the supplementary information associated with the UE and the TRP or the reset of the supplementary information to the positioning server.

In some embodiments, the positioning server may acquire multiple RTTs by repeating the steps 501-504 between the UE and a single TRP at multiple different times. In some embodiments, the positioning server may acquire multiple RTTs by performing the steps 501-504 between the UE and multiple TRPs concurrently; and the multiple TRPs move along the same orbit or in the same direction. Therefore, the positioning server may derive two locations, one is the actual UE location, and another is a mirror location of the UE.

Furthermore, it is contemplated that in some embodiments, it does not need to repeat the steps 506 and/or step 507 for each execution of steps 501-504, one execution of step 506 and/or step 507 associated with one RTT is enough for identifying the actual location of the UE and discarding the mirror location of the UE; in other words, it does not need to perform step 506 and/or step 507 for each RTT measurement during the multi-RTT positioning procedure.

In step 507, the positioning server identifies an actual UE location or discards a mirror location of the UE based on the multiple RTTs and the supplementary information associated with a RTT(s) during the multi-RTT positioning procedure in NTN.

To compensate the negative effect of the TRP movement and/or the UE movement during the multi-RTT positioning procedure, according to some embodiments of the present disclosure, for each RTT measurement result (including a first Rx-Tx time difference and a second Rx-Tx time difference associated with a UE and a TRP), at least one of the UE and a BS (or a node having the similar function) including the TRP may provide the positioning server with timing information associated with the RTT measurement result. The positioning server may use the timing information to compensate the negative effect of the TRP movement and/or the UE movement during the RTT measurement associated with the UE and the TRP.

In some embodiments, the BS provides the timing information associated with an RTT measurement result to the positioning server.

In some embodiments, the UE provides part of the timing information to the positioning server directly, and the BS provides the rest of the timing information to the positioning server directly.

In some embodiments, the UE provides part of the timing information to the BS, and the BS forwards the received part of the timing information and transmits the reset of the timing information to the positioning server.

In some embodiments, the timing information includes a first time point

$$( i . e . , {t}_{TRP}^{Tx} )$$

when the TRP transmits a DL signal to the UE and a second time point

$$( i . e . , {t}_{TRP}^{Rx} )$$

when the TRP receives an UL signal from the UE. In some embodiments, the timing information may further includes a third time point

$$( i . e . , {t}_{UE}^{R x} )$$

when the UE receives the DL signal and a fourth time point

$$( i . e . , {t}_{UE}^{Tx} )$$

when the UE transmits the UL signal. The BS provides the first time point and the second time point to the positioning server. In some embodiments, the UE provides the third time point and the fourth time point to the positioning server directly. In some embodiments, the UE provides the third time point and the fourth time point to the BS, and the BS forwards the received third time point and fourth time point to the poisoning server. In some embodiments, the BS derives the third time point and the fourth time point based at least on an RX-TX time difference measurement configuration and transmits these two time points to the positioning server, wherein in some embodiments, the RX-TX time difference measurement configuration is associated with a DL PRS transmission window and a UL SRS reception window.

In some embodiments, the timing information includes a UE-specific timing advance between the UE and the TRP at the second time point; the BS transmits the UE-specific timing advance to the positioning server. In some embodiments, the BS transmits a request to the UE to acquire the UE-specific timing advance between the UE and the TRP at the second time point from the UE. In some embodiments, the BS derives the UE-specific timing advance between the UE and the TRP at the second time point based on at least one of a previous UE-specific timing advance, a total adjusted timing advance before the second time point, and a common timing advance applied in a serving cell; for example, the BS may derive the UE-specific timing advance between the EU and the TRP at the second time point to be the previous UE-specific timing advance plus the total adjusted timing advance before the second time point minus the common timing advance applied in the serving cell.

In some embodiments, the timing information further includes at least one of the following, which is provided by the UE directly:
a UE-specific timing advance between the UE and the TRP at the second time point, wherein
   in some embodiments, the BS provides the second time point to the UE, and
   in some embodiments, the UE derives the second time point based on a UE-specific timing advance at the fourth time point;
a UE-specific timing advance variation between the fourth time point and the second time point, wherein
   in some embodiments, the BS provides the second time point to the UE, and
   in some embodiments, the UE derives the second time point based on a UE-specific timing advance at the fourth time point; or
a UE-specific timing advance variation rate at the fourth time point.

FIG. 6 illustrates a flowchart of an exemplary method 600 for calculating an RTT associated with a UE and a TRP according to some embodiments of the present disclosure, wherein the positioning server uses the received timing information to compensate the negative effect of the movement of at least one of the TRP and the UE during the RTT measurement. The method 600 illustrated in FIG. 6 may be performed by at least three entities, e.g., a UE (e.g., UE 101), a BS (or a node having the similar function, not explicitly shown in FIG. 1), and a positioning server (e.g., an LMF entity). Although the method 600 is illustrated in a system level, persons skilled in the art can understand that the method implemented in the three entities can be separately implemented and incorporated in other apparatus with the like functions. It is also contemplated that the method 600 may include additional steps not shown.

In step 601, the BS and the UE perform an RTT measurement between the UE and a TRP of the BS. The TRP transmits a DL signal to the UE, the UE receives and processes the DL signal, and then transmit a UL signal to the TRP, the TRP receives the UL signal. In some embodiments, the UL signal is UL SRS, and the DL signal is DL PRS.

In step 602, the BS transmits a first Rx-Tx time difference (i.e., RxTxDiff_{TRP}) between

$${t}_{TRP}^{Tx} and {t}_{TRP}^{Rx}$$

to the positioning server.

In step 603, the UE transmits a second Rx-Tx time difference (i.e., RxTxDiff_{UE}) between

$${t}_{UE}^{Rx} and {t}_{UE}^{Tx}$$

to the positioning server. It is contemplated that in some embodiments, there is no strict limit to the order of the step 602 and the step 603. In some embodiments, the UE may transmit the second Rx-Tx time difference to the BS, and the BS may forwards the second Rx-Tx time difference to the UE.

In some embodiments, whether step 604 or step 605 is executed, or both step 604 and step 605 are executed, it depends at least partly upon 1) the content of the timing information and/or 2) whether the TRP movement or both the TRP movement and the UE movement during the RTT measurement need to be compensated.

In some embodiments, in step 604, the UE provides the timing information associated with the UE and the TRP to the BS; and in step 605, the BS forwards the timing information associated with the UE and the TRP to the positioning server.

In some embodiments, in step 604, the UE provides the timing information associated with the UE and the TRP to the positioning server directly; and the step 605 is not executed.

In some embodiments, in step 604, the UE provides part of the timing information associated with the UE and the TRP to the BS; and in step 605, the BS forwards the received part of the timing information associated with the UE and the TRP and transmits the rest of the timing information to the positioning server.

In some embodiments, the step 604 is not executed, and the BS provides the timing information associated with the UE and the TRP to the positioning server.

In step 606, the positioning server calculates an RTT between the UE and the TRP based on the RTT measurement result (including the first Rx-Tx time difference and the second Rx-Tx time difference), and uses the timing information to compensate the negative effect of the TRP and/or UE movement during the RTT measurement, so as to achieve a adjusted RTT for positioning the UE.

To compensate the negative effect of the TRP movement and/or the UE movement during the multi-RTT positioning procedure, according to some embodiments of the present disclosure, for each RTT measurement result (including a first Rx-Tx time difference and a second Rx-Tx time difference associated with a UE and a TRP), the BS (or a node having the similar function) including the TRP transmits a first offset time difference of the RTT measurement result to the positioning server, wherein the first offset time difference compensates the negative effect of the TRP movement during the RTT measurement; the positioning server may use the first offset time difference instead of the first Rx-Tx time difference to calculate the RTT. In some embodiments, the UE may further transmit a second offset time difference of the RTT measurement to the positioning server, wherein the second offset time difference compensates the negative effect of the UE movement during the RTT measurement; the positioning server may use the second offset time difference instead of the second Rx-Tx time difference to calculate the RTT.

In some embodiments, the first offset time difference of the RTT measurement result equals to double of a time difference between the second time point and the fourth time point. Wherein in some embodiments, the BS receives the fourth time point from the UE; and wherein in some embodiments, the BS derives the fourth time point based at least on an RX-TX time difference measurement configuration. In some embodiments, the RX-TX time difference measurement configuration is associated with a DL signal (e.g., DL PRS) transmission window and a UL signal (e.g., UL SRS) reception window.

In some embodiments, the first offset time difference of the RTT measurement result equals to a UE-specific timing advance between the UE and the TRP at the second time point. In some embodiments, the BS transmits a request to the UE to acquire the UE-specific timing advance between the UE and the TRP at the second time point. In some embodiments, the BS derives the UE-specific timing advance between the UE and the TRP at the second time point based on at least one of a previous UE-specific timing advance, a total adjusted timing advance before the second time point, and a common timing advance applied in a serving cell; for example, the BS may derive the UE-specific timing advance between the EU and the TRP at the second time point to be the previous UE-specific timing advance plus the total adjusted timing advance before the second time point minus the common timing advance applied in the serving cell.

In some embodiments, the second offset time difference of the RTT measurement result is determined based on 1) a UE-specific timing advance variation between the fourth time point and the second time point and 2) the second Rx-Tx time difference. In some embodiments, the second offset time difference of the RTT measurement result equals to the second Rx-Tx time difference plus the UE-specific timing advance variation between the fourth time point and the second time point. In some embodiments, the second time point is provided by the BS to the UE. In some embodiments, the UE derives the second time point based on a UE-specific timing advance at the fourth time point.

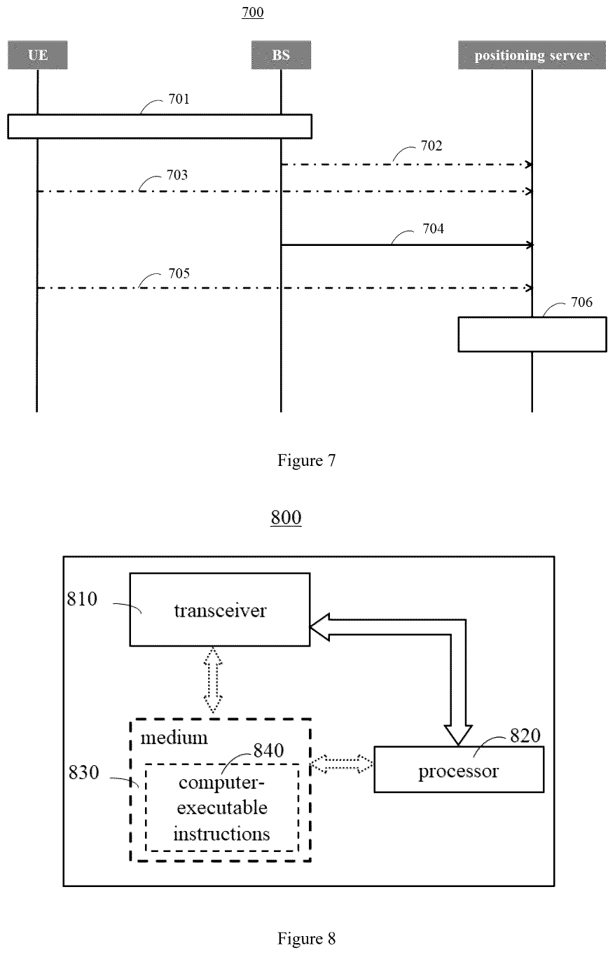

FIG. 7 illustrates a flowchart of an exemplary method 700 for calculating an RTT associated with a UE and a TRP according to some embodiments of the present disclosure, wherein the BS provides a first offset time difference of the RTT measurement result compensating the movement of the BS during the RTT measurement. In some embodiments, the UE may further provide a second offset time difference of the RTT measurement result compensating the movement of the UE during the RTT measurement. The method 700 illustrated in FIG. 7 may be performed by at least three entities, e.g., the UE (e.g., UE 101), the BS (or a node including the similar function, not explicitly shown in FIG. 1) including the TRP, and a positioning server (e.g., an LMF entity, not shown in FIG. 1). Although the method 700 is illustrated in a system level, persons skilled in the art can understand that the method implemented in the three entities can be separately implemented and incorporated in other apparatus with the like functions. It is also contemplated that the method 700 may include additional steps not shown.

In step 701, the BS and the UE perform an RTT measurement between the UE and a TRP of the BS. The TRP transmits a DL signal to the UE, the UE receives and processes the DL signal, and then transmit a UL signal to the TRP, the TRP receives the UL signal. In some embodiments, the UL signal is UL SRS, and the DL signal is DL PRS.

In step 702, the BS transmits a first Rx-Tx time difference (i.e., RxTxDiff_{TRP}) between

$${t}_{TRP}^{Tx} and {t}_{TRP}^{Rx}$$

### to the LMF.

In step 703, the UE transmits a second Rx-Tx time difference (i.e., RxTxDiff_{UE}) between

$${t}_{UE}^{Rx} and {t}_{UE}^{Tx}$$

to the LMF. It is contemplated that in some embodiments, there is no strict limit to the order of the step 702 and the step 703. In some embodiments, the UE may transmit the second Rx-Tx time difference to the BS, and the BS may forwards the second Rx-Tx time difference to the UE.

In some embodiments, in step 704, the BS transmits the first offset time difference of the RTT measurement result to the positioning server. In step 706, in case of receiving the first offset time difference, the positioning server may use the first offset time difference instead of the first Rx-Tx time difference to calculate the RTT between the UE and the TRP associated with the RTT measurement; the RTT equals the first offset time difference minus the second Rx-Tx time difference, and thus the negative effect of the TRP movement during the RTT measurement is compensated. It is contemplated that in some embodiments, in the case that step 704 is executed, step 702 is not executed; or the positioning server may ignore the received first Rx-Tx time difference.

In some embodiments, step 705 is executed in addition to the execution of step 704. In step 705, the UE further transmits the second offset time difference of the RTT measurement result to the positioning server. In step 706, in the case of receiving the second offset time difference, the positioning server may use the first offset time difference instead of the first Rx-Tx time difference and use the second offset time difference instead of the second Rx-Tx time difference to calculate the RTT between the UE and the TRP associated with the RTT measurement; the RTT equals the first offset time difference minus the second offset time difference, and thus the negative effect of the TRP movement and the UE movement during the RTT measurement are compensated. It is contemplated that in some embodiments, in the case that step 704 and step 705 are executed, step 702 and step 703 are not executed; or the positioning server may ignore the received first Rx-Tx time difference and the received second Rx-Tx time difference.

According to some embodiments of the present disclosure, the positioning server may transmit a request to at least one of the UE and the BS to acquire the assistant measurement information from the at least one of the UE and the BS.

According to some embodiments of the present disclosure, the positioning server may configure at least one of the UE and the BS to transmit the assistant measurement information after an RTT measurement, or during or after the multi-RTT positioning procedure.

It is contemplated that in some embodiments, the supplementary information associated with the UE and the TRP and timing information associated with the RTT measurement may be used in combination to improve the accuracy of the multi-RTT positioning for a UE.

It is contemplated that in some embodiments, the supplementary information associated with the UE and at least one of the first offset time difference and the second offset time difference of the RTT measurement may be used in combination to improve the accuracy of the multi-RTT positioning for a UE.

It is contemplated that without violating the spirit of the present disclosure, any methods or solutions described in the present disclosure may be used in combination to improve the accuracy of the multi-RTT positioning for a UE in NTN.

FIG. 8 illustrates a simplified block diagram of an exemplary apparatus 800 according to some embodiments of the present disclosure.

In some embodiments, the apparatus 800 may be or include at least part of a UE (e.g., UE 101) which is capable of performing any of the operations performed by a UE as described in the present disclosure.

In some embodiments, the apparatus 800 may be or include at least part of a BS (or a node having the similar function, not explicitly shown in FIG. 1) which is capable of performing any of the operations performed by a BS as described in the present disclosure.

In some embodiments, the apparatus 800 may be or include at least part of a positioning server (not explicitly shown in FIG. 1) which is capable of performing any of the operations performed by a positioning server as described in the present disclosure.

As shown in FIG. 8, the apparatus 800 may include at least a transceiver 810 and a processor 820 coupled to the transceiver 810. In some embodiments, the transceiver 810 may include a transmitter and a receiver integrated together. In some embodiments, the transceiver 810 may include a transmitter and a receiver which are separated from each other. In some embodiments, the transceiver 810 may be a wireless transceiver.

In some embodiments, the apparatus 800 may include a non-transitory computer-readable medium 830 with computer-executable instructions 840 stored thereon. The non-transitory computer-readable medium 830 may be coupled to the processor 820 and the transceiver 810, and the computer-executable instructions 840 may be configured to be executable by the processor 820. In some embodiments, the transceiver 810, the non-transitory computer-readable medium 830, and the processor 820 may be coupled to each other via one or more local buses.

Although in FIG. 8, elements such as the transceiver 810, the non-transitory computer-readable medium 830, and the processor 820 are described in the singular, the plural is contemplated unless limitation to the singular is explicitly stated. In certain embodiments of the present disclosure, the apparatus 800 may further include other components for actual usage.

In various example embodiments, the processor 820 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 820 may also include at least one other circuitry or element not shown in FIG. 8.

In various example embodiments, the non-transitory computer-readable medium 830 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 830 may include, but is not limited to, an electric, a magnetic, an optical, an electromagnetic, an infrared, or a semiconductor system, apparatus, or device or any combination of the above.

Further, in various example embodiments, the apparatus 800 may also include at least one other circuitry, element, and interface, for example antenna element, and the like.

According to some embodiments, the apparatus 800 is a positioning server. The transceiver 810 and the processor 820 may be configured to perform operations in any methods described above which are performed by a positioning server. For example, the processor 820 may be configured to: receive, with the transceiver and from at least one of a BS or a UE, assistant measurement information associated with an RTT measurement between the UE and a TRP of the BS; and determine an RTT and locate the UE during a multi-RTT positioning procedure based at least partly on the assistance measurement information and an RTT measurement result, wherein the assistant measurement information includes at least one of the following: supplementary information associated with the UE and the TRP; timing information associated with the RTT measurement result; a first offset time difference of the RTT measurement result for the TRP; or a second offset time difference of the RTT measurement result for the UE.

According to some embodiments, the apparatus 800 is a BS. The transceiver 810 and the processor 820 may be configured to perform operations in any methods described above which are performed by a BS. For example, the processor 820 may be configured to: perform an RTT measurement between a UE and a TRP of the BS; and transmit assistant measurement information and an RTT measurement result (i.e., a first Rx-Tx time difference) associated with the RTT measurement to a positioning server, wherein the assistant measurement information includes at least one of the following: supplementary information for locating the UE; timing information associated with the RTT measurement result; a first offset time difference associated with the RTT measurement result.

According to some embodiments, the apparatus 800 is a UE. The transceiver 810 and the processor 820 may be configured to perform operations in any methods described above which are performed by a UE. For example, the processor 820 may be configured to: perform an RTT measurement between the UE and a TRP of a BS; and transmit assistant measurement information associated with the RTT measurement and an RTT measurement result (i.e., a second Rx-Tx time difference) to at least one of the BS or a positioning server, wherein the assistant measurement information includes at least one of the following: supplementary information for locating the UE; timing information associated with the RTT measurement result; or a second offset time difference associated with the RTT measurement result.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.” In this disclosure, relational terms such as “first,” “second,” and the like may be used solely to distinguish one entity or action from another entity or action without necessarily requiring or implying any actual such relationship or order between such entities or actions.

1. A positioning server of a wireless network, comprising:
at least one memory; and
at least one processor coupled with the at least one memory and configured to cause the positioning server to:
receive, from a user equipment (UE), assistant measurement information associated with a round trip time (RTT) measurement; and
determine an RTT and locate the UE during a multi-RTT positioning procedure based at least partly on the assistance measurement information and an RTT measurement result, wherein
the assistant measurement information includes at least one of the following:
timing information associated with the RTT measurement result;
or
an offset time difference of the RTT measurement result for the UE.

2. (canceled)

3. The positioning server of claim 1, wherein the timing information associated with the RTT measurement result includes:
a first time point when a transmission and reception point (TRP) transmits a downlink (DL) signal to the UE, and
a second time point when the TRP receives an uplink (UL) signal from the UE.

4. The positioning server of claim 3, wherein the timing information associated with the RTT measurement result further includes:
a third time point when the UE receives the DL signal and a fourth time point when the UE transmits the UL signal.

5. (canceled)

6. The positioning server of claim 1, wherein the at least one processor is further configured to cause the positioning server to transmit a request to or configures the UE to receive the assistant measurement information.

7. A user equipment (UE) for wireless communication, comprising:
at least one memory; and
at least one processor coupled with the at least one memory and configured to cause the UE to:
perform a round trip time (RTT) measurement between the UE and a transmission and reception point (TRP) of a base station (BS); and
transmit assistant measurement information associated with the RTT measurement and an RTT measurement result to at least one of the BS or a positioning server, wherein the assistant measurement information includes at least one of the following:
timing information associated with the RTT measurement; or
an offset time difference associated with the RTT measurement.

8. (canceled)

9. The UE of claim 7, wherein the timing information associated with the RTT measurement includes:
a first time point when the UE receives a downlink (DL) signal from the TRP; and a second time point when the UE transmits an uplink (UL) signal to the TRP.

10. A base station (BS) for wireless communication, comprising:
at least one memory; and
at least one processor coupled with the at least one memory and configured to cause the BS to:
perform a round trip time (RTT) measurement between a user equipment (UE) and a transmission and reception point (TRP) of the BS; and
transmit assistant measurement information and an RTT measurement result associated with the RTT measurement to a positioning server, wherein
the assistant measurement information includes at least one of the following:
timing information associated with the RTT measurement result; or
an offset time difference.

11. (canceled)

12. The BS of claim 10, wherein the timing information associated with the RTT measurement result includes:
a first time point when the TRP transmits a downlink (DL) signal to the UE, and
a second time point when the TRP receives an uplink (UL) signal from the UE.

13. The BS of claim 12, wherein the timing information associated with the RTT measurement result further includes:
a third time point when the UE receives the DL signal from the TRP, and
a fourth time point when the UE transmits the UL signal to the TRP.

14. The BS of claim 10, wherein the offset time difference equals to double of a time difference between a fourth time point when the UE transmits a UL signal and a second time point when the TRP receives a UL signal from the UE.

15. The BS of claim 13, wherein:
a third time point when the UE receives the DL signal from the TRP and the fourth time point are derived based at least on a reception-transmission (RX-TX) time difference measurement configuration; or
the third time point when the UE receives the DL signal from the TRP and the fourth time point are received from the UE.

16. A method performed by a user equipment (UE), the method comprising:
performing a round trip time (RTT) measurement between the UE and a transmission and reception point (TRP) of a base station (BS); and
transmitting assistant measurement information associated with the RTT measurement and an RTT measurement result to at least one of the BS or a positioning server, wherein the assistant measurement information includes at least one of the following:
timing information associated with the RTT measurement; or
an offset time difference associated with the RTT measurement.

17. The method of claim 16, wherein the timing information associated with the RTT measurement includes:
a first time point when the UE receives a downlink (DL) signal from the TRP; and a second time point when the UE transmits an uplink (UL) signal to the TRP.
